(19) United States
(12) Patent Application Publication
(10) Pub. No.: US 2018/0232427 A1
(43) Pub. Date: Aug. 16, 2018

(54) DATA STRUCTURE ENDIAN CONVERSION SYSTEM

(71) Applicant: Raytheon Company, Waltham, MA (US)

(72) Inventor: Scott W. Spicer, Redondo Beach, CA (US)

(21) Appl. No.: 15/431,170

(22) Filed: Feb. 13, 2017

(51) Int. Cl. G06F 17/30; H04L 12/58; H04L 29/08

(52) U.S. Cl. CPC G06F 17/30569; H04L 67/10; H04L 51/04

(57) ABSTRACT

A system that provides a service via a computer networking protocol converts input data from one endian type to another endian type according to a specified format of the input data. A method for converting data from one endian type to another endian type includes receiving a first data message having a plurality of data words via a computer networking protocol, stepping through a plurality of data format definitions of a data format specification that defines a data format of each of the plurality of data words according to a data type of the first data message while stepping through the plurality of data words at intervals according to the data format of each of the plurality of data words, converting a first data word of the plurality of data words from one endian type to a corresponding second data word of another endian type by byte swapping bytes of the first data word according to the data format of the first data word, and transmitting a second data message having the second data word via the computer networking protocol.

### GOVERNMENT LICENSE RIGHTS

This invention was made with government support under government contract awarded by the Department of Defense. The government has certain rights in the invention.

### TECHNICAL FIELD

Embodiments generally relate to computing including computer networking and computational data processing, and more particularly to a data structure endian conversion system.

### BACKGROUND

Computing processors can be categorized as either big-endian or little-endian. A big-endian machine represents binary numbers having more than one byte with the most significant byte on the left side of a sequence of bytes in a data word. A little-endian machine represents binary numbers having more than one byte with the most significant byte on the right side of the sequence of bytes in the data word. When sending data from one of a big-endian or little-endian machine to the other of a big-endian or little-endian machine, the data may be processed incorrectly because the second of the two machines may not interpret the received data properly according to its endianness. Endian conversion can be used to convert the data from one of big-endian or little-endian to the other of big-endian or little-endian when the data is sent from one of a big-endian or little-endian machine to the other of a big-endian or little-endian machine in order to address this problem. Endian conversion consists of swapping the byte order of the binary data word. The least significant byte is swapped with the most significant byte, the next-to-least significant byte is swapped with the next-to-most significant byte, etc., to reverse the order of the bytes when going from one of the big-endian or little-endian representation to the other of big-endian or little-endian representation.

### SUMMARY

When data intended to be processed by a big-endian computing processor is instead processed by a little-endian computing processor, or vice versa, the data may be processed incorrectly and the processing results may be incorrect. This may occur, for example, when a big-endian computing processor of a big-endian computing system is replaced with a little-endian computing processor, or a system including a little-endian computing processor is used to process data originally generated by a system designed for or including a big-endian computing processor. One typical solution would be to replace or modify all components of the computing system to match the endianness of the computing processor used to process the data. These modifications may include modifications to electronic hardware, e.g., sensors, as well as modifications to computer software. This solution, however, could be very expensive or not feasible given various cost and time constraints.

Embodiments include a network service that converts input data from one endian type to another endian type according to a specified format of the input data. The network service appears to users as a block box that communicates via a computer networking protocol, e.g., Transmission Control Protocol/Internet Protocol (TCP/IP). Because the network service has a standardized input/output interface, it can be widely compatible with a wide variety of different types of systems and not require complicated or invasive changes to system components to convert them from one endian type to another endian type. The network service separates the endian type conversion from issues of hardware and software programming language compatibility. The network service can serve as middleware between components of one endian type and components of another endian type. A data generating component of one endian type may send data to the network service via a computer networking protocol for endian conversion, then the network service may send the converted data to the data processing component of an opposite endian type via a computer networking protocol for processing. The computer networking protocol between the data generating component, network service, and data processing component can be used across a wide range of systems, e.g., within a single computing system, over a local area network, over a wide area network, over Wi-Fi®, over Ethernet, over Long-Term Evolution (LTE), over a wide area network, over the Internet, etc.

According to an embodiment, a method of converting data from one endian type to another endian type includes receiving a first data message having a plurality of data words via a computer networking protocol, stepping through a plurality of data format definitions of a data format specification that defines a data format of each of the plurality of data words according to a data type of the first data message while stepping through the plurality of data words at intervals according to the data format of each of the plurality of data words, converting a first data word of the plurality of data words from one endian type to a corresponding second data word of another endian type by byte swapping bytes of the first data word according to the data format of the first data word, and transmitting a second data message having the second data word via the computer networking protocol.

According to an embodiment, a data structure endian conversion system includes a data receiver to receive a first data message having a plurality of data words via a computer networking protocol, an endian conversion element to step through a plurality of data format definitions of a data format specification that defines a data format of each of the plurality of data words according to a data type of the first data message while stepping through the plurality of data words at intervals according to the data format of each of the plurality of data words, and to convert a first data word of the plurality of data words from one endian type to a corresponding second data word of another endian type by byte swapping bytes of the first data word according to the data format of the first data word, and a data transmitter to transmit a second data message having the second data word via the computer networking protocol.

According to an embodiment, at least one non-transitory machine-readable medium includes instructions that, when executed by a machine, cause the machine to perform the following operations: receiving a first data message having a plurality of data words via a computer networking protocol, stepping through a plurality of data format definitions of a data format specification that defines a data format of each of the plurality of data words according to a data type of the first data message while stepping through the plurality of data words at intervals according to the data format of each of the plurality of data words, converting a first data word of the plurality of data words from one endian type to a corresponding second data word of another endian type by byte swapping bytes of the first data word according to the data format of the first data word, and transmitting a second data message having the second data word via the computer networking protocol.

### BRIEF DESCRIPTION OF THE DRAWINGS

FIG. 1 is a block diagram that illustrates a data structure endian conversion system provided as a network service over a computing network, in accordance with some embodiments.

FIG. 2 is a block diagram that illustrates components of the data structure endian conversion system of FIG. 1, in accordance with some embodiments.

FIG. 3 is a block diagram that illustrates a data flow into and out of an endian conversion element of FIG. 2, in accordance with some embodiments.

FIG. 4 is a block diagram that illustrates a method of performing an endian conversion of a data message via computer networking according to a data format of the data message, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

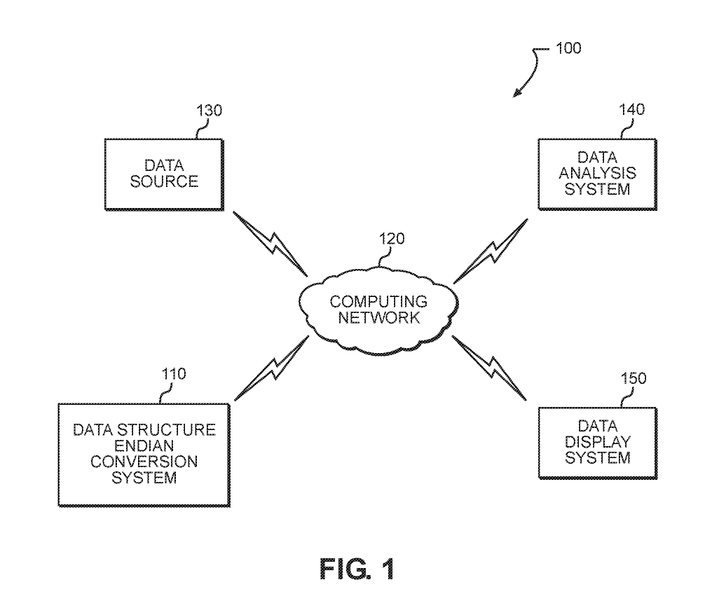

FIG. 1 is a block diagram that illustrates a computing system 100 including a data structure endian conversion system 110 provided as a network service over a computing network 120, in accordance with some embodiments. The computing network 120 may include any of a data bus within a single computing system, a local area network, a wide area network, a Wi-Fi® network, an Ethernet network, a Long-Term Evolution (LTE) network, a wide area network, the Internet, or other computer networking medium. The data structure endian conversion system 110 may communicate with users over the computing network 120, and thereby receive data to be endian-converted from a data source 130 and provide endian-converted data to one or more components that process the endian-converted data, e.g., a data analysis system 140 and a data display system 150. The users of the data structure endian conversion system 110 may include various hardware and software components of a computing system, e.g., the data source 130, the data analysis system 140, and the data display system 150. In various embodiments, the data structure endian conversion system 110 may be part of a same computing system as the data source 130, data analysis system 140, and/or data display system 150. In various embodiments, the data structure endian conversion system 110 may include a computer system that is independent of the data source 130, data analysis system 140, and/or data display system 150, and communicatively coupled with the data source 130, data analysis system 140, and/or data display system 150 over the computing network 120 using a common computer networking communications protocol, e.g., TCP/IP.

The data source 130 may include any provider or generator of data. For example, the data source 130 may include providers or generators of video data, audio data, still image data textual data, numerical data, measurement data, calculated data, stored data, etc. The data source 130 may include hardware components, e.g., sensors, that may measure and report measured data such as temperature, humidity, pressure, velocity, or any of a variety of environmental, performance, or other measurable parameters. The data source 130 may include a data storage device that stores data in a non-volatile memory or a computing processor that generates data through computations. The data source 130 may have an endian type that is incompatible with an intended recipient of the data provided by the data source 130. Rather than send the data directly to an intended recipient that is of an endian type that is incompatible with the endian type of the data, the data source 130 may send the data to the data structure endian conversion system 110 over the computing network 120 to be converted from the data's endian type to the endian type of the intended recipient. The data source 130 may send the data to the data structure endian conversion system 110 according to predetermined network addressing information including a network address of the data structure endian conversion system 110 and a port used for receiving input data via the computing network 120 to be endian-converted. The data source 130 may also specify to the data structure endian conversion system 110 network addressing information for the intended recipient that the data structure endian conversion system 110 should send the endian-converted data to upon being endian-converted.

The data to be endian-converted may be provided by the data source 130 to the data structure endian conversion system 110 in the form of a data message or data stream that includes one or more data words of one or more different lengths and formats, e.g., an 8 bit character value, a 16 bit short value, 32 bit integer value, a 32 bit floating point value, a 64 bit double value, and/or a multiple-byte character string value. The data source 130 may also provide the data structure endian conversion system 110 with a specification of a data type of the data message and/or a data format definition for each data word in the data message in conjunction with sending the data to the data structure endian conversion system 110. The data type of the data message may determine the quantity, data format, and order of the data words in the data message. The data type may be specific to a particular computing system implementation, and may correspond with a data format specification that specifies the quantity, data format, and order of the data words in the data message.

The data structure endian conversion system 110 may receive the data message or data stream from the data source 130 and step through a plurality of data format definitions of a data format specification that defines a data format of each of the plurality of data words according to the data type of the data message received from the data source 130. While stepping through the plurality of data format definitions, the data structure endian conversion system 110 may step through the plurality of data words received from the data source 130 at intervals according to the data format of each of the plurality of data words, and convert the endianness of each data word by byte swapping the bytes of the data word according to the data format definition corresponding to the data word. The data format specification may be defined by a file, e.g., a JavaScript Object Notation (JSON) file or extensible markup language (XML) file, that specifies the quantity, data format, and order of the data words in the data message according to a standard for reliable communications between the data source 130, data structure endian conversion system 110, and data user (e.g., data analysis system 140 or data display system 150). The data format of the plurality of data word may include the endianness of the data words, a number of bytes as a length of each data word, and an encoding of each data word, e.g., identification of the data word as a signed byte, unsigned byte, signed short, unsigned short, signed integer, unsigned integer, signed long, unsigned long, floating point, double precision floating point, Boolean, character, string, or the like. The data structure endian conversion system 110 may transmit an endian-converted data message including the endian-converted words in a format according to the data format specification to the intended recipient, e.g., the data analysis system 140.

The data analysis system 140 may receive the endian-converted data message from the data structure endian conversion system 110 via the computing network 120 using a computer networking communications protocol, e.g., TCP/IP. In systems in which the data analysis system 140 has a different endianness than the data source 130, the data analysis system 140 may process the endian-converted data message as if the data message was received from a data source that was the same endianness as the data analysis system 140. The processing performed by the data analysis system 140 on the received endian-converted data message may include data extraction, categorization, and statistical analysis. The data analysis system 140 may send analysis results to the data display system 150 over the computing network 120 to be displayed. In embodiments in which the data analysis system 140 and the data display system 150 have a same endianness, the data analysis system 140 may send the analysis results directly to the data display system 150 over the computing network 120. In embodiments in which the data analysis system 140 and the data display system 150 have a different endianness, the data analysis system 140 may send the analysis results to the data structure endian conversion system 110 to be endian-converted and subsequently sent to the data display system 150 over the computing network 120 after being endian-converted.

In various embodiments, the data display system 150 may receive the endian-converted data message from the data structure endian conversion system 110 via the computing network 120 using a computer networking communications protocol, e.g., TCP/IP, and display the data contained therein. In various embodiments, the data display system 150 may receive the data message including data to be displayed from the data analysis system 140 via the computing network 120, and display the data contained therein. In systems in which the data display system 150 has a different endianness than the data analysis system 140, the data display system 150 may process the endian-converted data message received from the data structure endian conversion system 110 as if the data message was received from a data analysis system 140 that was the same endianness as the data display system 150. In embodiments in which the data analysis system 140 and the data display system 150 have a same endianness, the data display system 150 may receive the analysis results directly from the data analysis system 140 over the computing network 120.

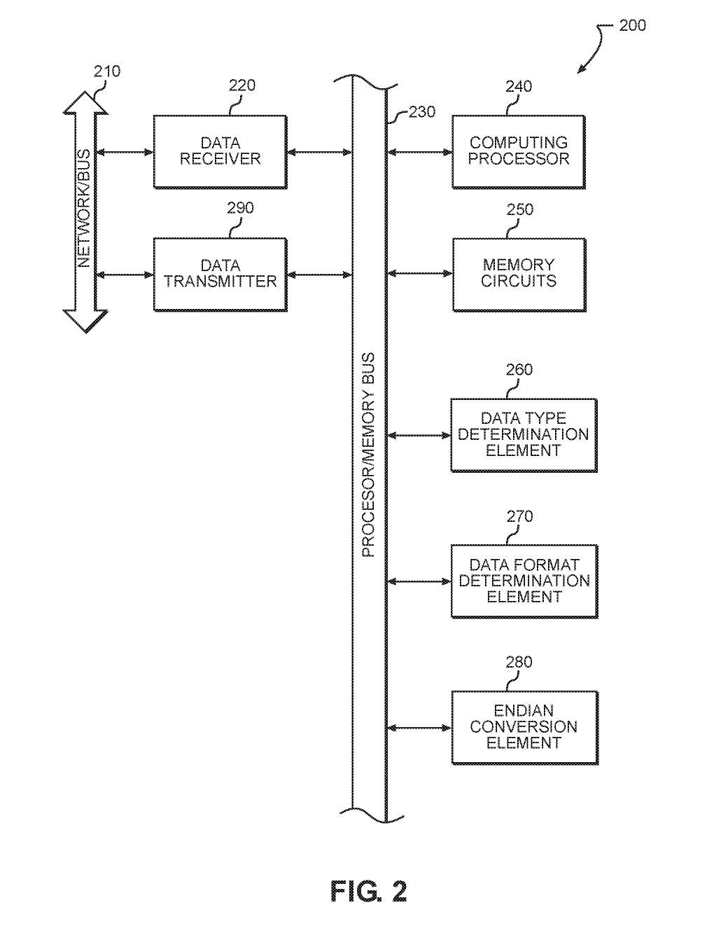

FIG. 2 is a block diagram that illustrates components of a data structure endian conversion system 200, in accordance with some embodiments. The data structure endian conversion system 200 may be an embodiment of the data structure endian conversion system 110 of FIG. 1. A data receiver 220 may receive a data message from a network/bus 210 according to a computer networking protocol, e.g., TCP/IP. The network/bus 210 may be an embodiment of the computing network 120. In various embodiments, the network/bus 210 may include a data bus within a computer system. The data receiver 220 may include an electronic receiver circuit that converts an incoming electrical signal from the network/bus 210 into a data message including data bits, bytes, and words that can be stored and/or processed by the data structure endian conversion system 200. The data receiver 220 may also receive a specification of a data type of the data message and/or a data format of each data word in the data message in conjunction data message received from the network/bus 210. The specification of the data type of the data message may be provided as a field within the data message itself. In some embodiments, the specification of the data type of the data message may be predetermined and known a priori, or be predetermined according to the transmitter of the data message to the data receiver 220, and therefore be known by the data structure endian conversion system 200 without further specification. The data receiver 220 may also receive network addressing information for the end user that the data structure endian conversion system 200 should send the endian-converted data message to upon being endian-converted. The data receiver 220 may send the received data message, its associated data type specification, and/or the network addressing information for the end user via a processor/memory bus 230 to a computing processor 240 and/or memory circuits 250. The processor/memory bus 230 may include one or more data, processor, and/or memory buses within the data structure endian conversion system 200.

The computing processor 240 may include one or more computing processor circuits, including a central processing unit (CPU), a microcontroller, and/or a direct memory access controller. The computing processor 240 may transfer the data message, its associated data type specification, and/or the network addressing information for the end user received by the data receiver 220 to the memory circuits 250 for storage. The computing processor 240 may transfer the data message, its associated data type specification, and/or the network addressing information for the end user received by the data receiver 220 and/or stored in the memory circuit 250 to one or more registers for processing by the computing processor 240. The memory circuits 250 may also include computing instructions stored therein to be executed by the computing processor 240 to perform an endian type conversion of the data message received by the data receiver 220. The memory circuits 250 may include volatile memory, e.g., dynamic random access memory circuits (DRAM) or static random access memory (SRAM), or non-volatile memory, e.g., flash memory circuits.

An endian conversion element 280 may endian-convert the data message received by the data receiver 220. The endian conversion element 280 may receive the data message and/or its associated data type specification from the data receiver 220, computing processor 240, and/or memory circuits 250 via the processor/memory bus 230. The endian conversion element 280 may call a data type determination element 260 and a data format determination element 270 to determine the data type of the received data message and the location and data format of each data word included in the data message. In embodiments where the data type of the received data message is known a priori, the endian conversion element 280 may not call the data type determination element 260. In embodiments where the data format of each word within the data message is known a priori, the endian conversion element 280 may not call the data format determination element 270. The data type determination element 260, the data format determination element 270, and/or the endian conversion element 280 may include a computing processor and/or logic circuits, for example, in an application specific integrated circuit (ASIC), field-programmable gate array (FPGA), or integrated circuit (IC). In various embodiments, the data type determination element 260, the data format determination element 270, and/or the endian conversion element 280 may be included on a same integrated circuit chip or on a different integrated circuit chips.

The endian conversion element 280 may step through a plurality of data format definitions of a data format specification that defines a data format of each of a plurality of data words in the data message while stepping through each data word included in the data message at intervals according to the data format of each data word. While stepping through each data word, the endian conversion element 280 may endian convert the data word based on the data word's format. The data format specification may include a file that specifies the location and format of each data word in the data message. The endian conversion of each individual data word in the data message may be performed by performing a byte swapping of all the bytes in the data word from a most significant byte position to a least significant byte position. For example, the most significant byte may be swapped with the least significant byte, then the next most significant byte may be swapped with the next least significant byte, etc., until all the bytes of the data word are swapped to perform the endian conversion of the data word.

The data type determination element 260 may analyze the data message and/or its associated data type specification received by the data receiver 220 and determine a data type of the data message received by the data receiver 220. The data type of the data message may include a specification of a location and a data format of each data word in the data message. The data type of the data message may determine the quantity, data format, and order of the data words in the data message. The data type may be specific to a particular computing system implementation, and may correspond with a data format specification that specifies the quantity, data format, and order of the data words in the data message. In some embodiments in which the data type is predefined and known a priori, the data type determination element 260 may not be included in the data structure endian conversion system 200.

The data format determination element 270 may determine a data format of the data word received by the data receiver 220 according to the data format specification that corresponds with the data type of the data message as determined by the data type determination element 260. The data format specification may be defined by a file, e.g., a JSON file or XML file, which specifies the quantity, data format, and order of the data words in the data message according to a computer network communications standard by which the data receiver 220 receives the data message. In some embodiments, a file defining the data format specification for each of one or more predefined data types may be stored in the memory circuits 250 and be chosen and accessed by the data format determination element 270 over the processor/memory bus 230 according to a field of the data message received by the data receiver 220. The data format of each data word may include the endianness of the data word, a number of bytes as a length of the data word, and an encoding of the data word, e.g., identification of the data word as a signed byte, unsigned byte, signed short, unsigned short, signed integer, unsigned integer, signed long, unsigned long, floating point, double precision floating point, Boolean, character, string, or the like. The data format may be specific to a particular computing system implementation, and may specify the quantity, data format, and order of the data words in the data message. In some embodiments in which the data format is predefined and known a priori, the data format determination element 270 may not be included in the data structure endian conversion system 200.

Following endian conversion of the data message received by the data receiver 220, the endian conversion element 280 and/or the computing processor 240 may send the endian-converted data message to a data transmitter 290 over the processor/memory bus 230 for transmission over the network/bus 210 to an end user of the endian-converted data message. The data transmitter 290 may transmit the endian-converted data message to the end user according to the network addressing information for the end user received by the data receiver 220, or according to predetermined end user network addressing information stored in the memory circuits 250.

The data transmitter 290 may include an electronic data transmitter circuit that transmits electronic signals over a communication medium, e.g., the network/bus 210, to represent a data message including the data bits, bytes, and words that can be stored and/or processed by the data structure endian conversion system 200. The endian-converted data message may be transmitted over the network/bus 210 using a computer networking protocol, e.g., TCP/IP, to the end user of the endian-converted data message. The computer networking protocol used to transmit the endian-converted data message may be the same as the computer networking protocol by which the data message is received by the data receiver 220. In some embodiments, the computer networking protocol used to transmit the endian-converted data message may be different from the computer networking protocol by which the data message is received by the data receiver 220. The endian-converted data message may be transmitted to a different location than that from which the data message is received by the data receiver 220. A data type of the endian-converted data message may be determined according to the data type of the data message received by the data receiver 220. A specification of the data type of the endian-converted data message and/or a data format of each data word in the endian-converted data message may be transmitted in conjunction with the endian-converted data message. The specification of the data type of the endian-converted data message may be provided as a field within the endian-converted data message itself.

While the network/bus 210, data receiver 220, and data transmitter 290 are discussed herein as being for electronic wired or wireless data communications, this should not be construed as limiting, as in various embodiments, the network/bus 210 may include an optical communications medium such as an optical waveguide, optical fiber, or free space, and the data receiver 220 and data transmitter 290 may include optical receivers, e.g., photodiodes, and optical transmitters, e.g., light emitting diodes (LEDs) and lasers, respectively.

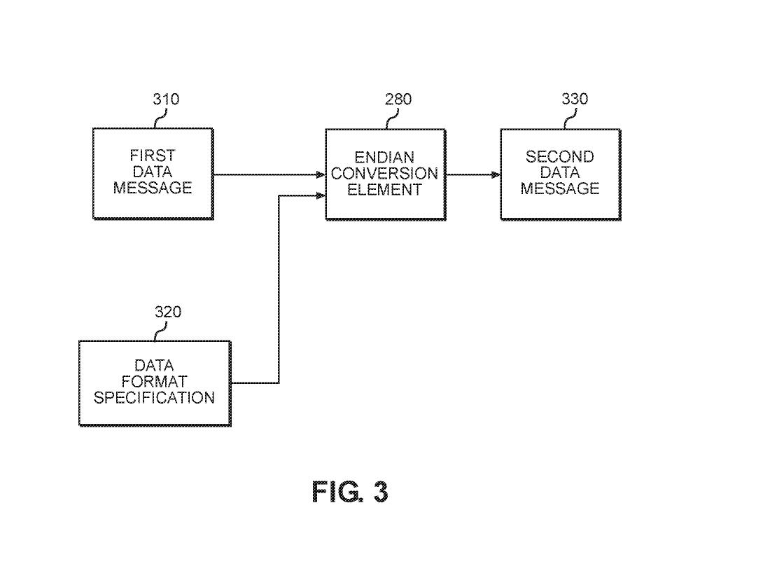

FIG. 3 is a block diagram that illustrates a data flow into and out of the endian conversion element 280 of FIG. 2, in accordance with some embodiments. A first data message 310, e.g., as received by the data receiver 220 of the data structure endian conversion system 200, and a data format specification 320, e.g., as determined by the data format determination element 270 of the data structure endian conversion system 200, may be provided to the endian conversion element 280. The data format specification 320 may specify the location and format of each data word included in the first data message 310. In an embodiment, the data format specification 320 may include a JSON file. Following is an example of a JSON file that specifies the data format of a data message:

```
{
      “byte_size” : 12,
      “data_endianness” : “BIG”,
      “fields” : {
            “count” : {
                  “byte_offset” : 0,
                  “byte_size” : 4,
                  “encoding” : “signed”
            }
            “size” : {
                  “byte_offset” : 4,
                  “byte_size” : 8,
                  “encoding” : “unsigned”
            }
}
```

In the above JSON file example, the fields are described as follows:
“byte_size”: total number of bytes in the data structure, with each byte having 8 bits
“data_endianness”: representation of all values in the data structure being either “BIG” for big-endian representation, or “LITTLE” for little-endian
“fields”: a name designating a JSON object having specific fields as defined in the portion between the following brackets
“byte_offset”: a total number of bytes offset from the start of the top-level data structure for the current JSON object between the brackets
“byte_size”: a number of bytes that the current JSON object occupies
“encoding”: how the data within the byte is encoded, e.g., can be “signed” to designate a signed integer, “unsigned” to designate an unsigned integer, “float” to designate a standard single-precision floating point value, “double” to designate a double-precision floating point value, or other types of encodings as may be defined

Note that in the above example, the data structure includes a 4 byte signed value named “count” that is followed by an 8 byte unsigned value named “size”. To endian convert the data structure, the 4 byte value named “count” is byte-swapped from its most significant byte to its least significant byte, then the 8 byte value named “size” that follows the 4 byte value named “count” is byte-swapped from its most significant byte to its least significant byte.

The endian conversion element 280 may step through each field entry in the data format specification 320 while stepping through the corresponding bytes of the first data message 310 and endian-convert each of the data words in the first data message 310 according to the characteristics of the respective data words specified in the data format specification 320. The endian conversion element 280 may then output a second data message 330 that includes the endian-converted data words in an order and format as originally provided in the first data message 310, except for their endianness. In some embodiments, the endian conversion element 280 may stream the second data message 330 in real-time while converting the first data message 310. In some embodiments, the endian conversion element 280 may store the endian-converted data words of the first data message 310 while performing the endian conversion of the first data message 310, and then output the second data message 330 as an endian-converted version of the first data message 310 after the endian conversion is complete. The contents of the second data message 330 may be identical to the first data message 310 except that the data words are endian-converted, e.g., from big-endian data words to little-endian data words, or vice-versa.

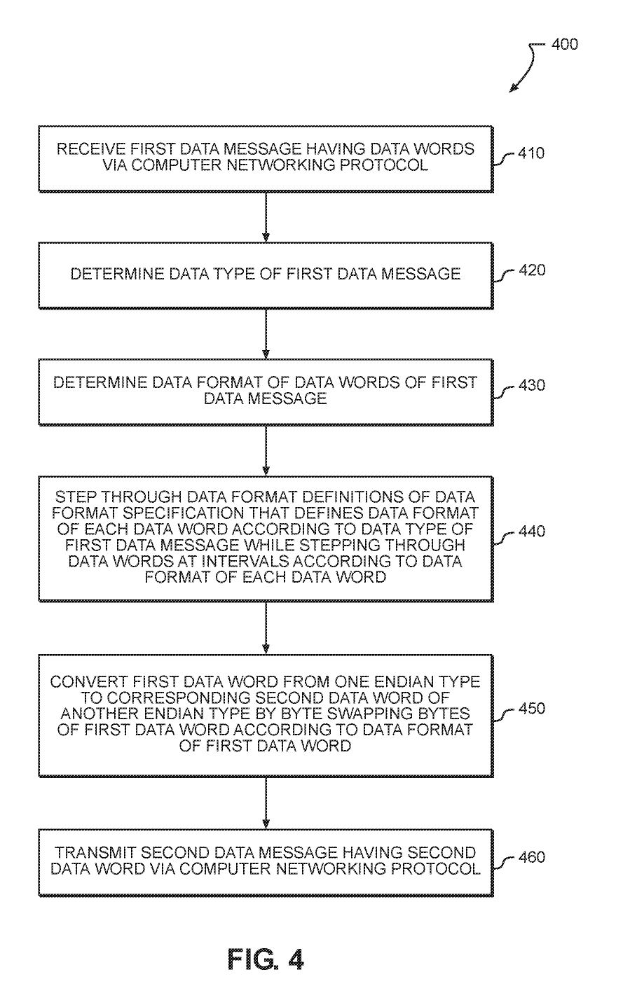

FIG. 4 is a block diagram that illustrates a method 400 of performing an endian conversion of a data message via computer networking according to a data format of the data message, in accordance with some embodiments. The endian conversion may convert data from one endian type to another endian type. The method 400 may be performed using the data structure endian conversion system 110 or 200.

In an operation 410, a first data message having a plurality of data words may be received via a computer networking protocol, e.g., TCP/IP. The first data message may be received by a data receiver 220 (shown in FIG. 2) over a network/bus 210 (shown in FIG. 2) within a computer system using the computer networking protocol. A specification of a data type of the first data message and/or a data format of each data word in the first data message may be received in conjunction with the first data message. The specification of the data type of the first data message may be provided as a field within the first data message itself. Network addressing information for the end user of a second data message as an endian-converted version of the first data message may also be received in conjunction with the first data message.

In an operation 420, a data type of the first data message may be determined. The data type may be determined by a data type determination module 260 (shown in FIG. 2), for example, by analyzing the first data message and/or its associated data type specification. The data type of the data message may include a specification of a location and a data format of each data word in the data message. The data type of the data message may determine the quantity, data format, and order of the data words in the data message. The data type may be specific to a particular computing system implementation, and may correspond with a data format specification that specifies the quantity, data format, and order of the data words in the data message. In some embodiments, the data type of the first data message may be determined according to the source of the data message, which may be identified through the computer networking protocol by which the first data message is received. In some embodiments, the data type of the first data message may be predetermined or known a priori, and no analysis of the first data message to determine the data type may be performed when the data type is predetermined.

In an operation 430, a data format of the plurality of data words of the first data message may be determined. The data format of the plurality of data words may correspond with the data type of the first data message as determined in operation 420. The data format may be determined by a data format determination module 270 (shown in FIG. 2), for example, according to a data format specification. The data format specification may be defined by a file, e.g., a JSON or XML file, that specifies the quantity, data format, and order of the data words in the data message. In some embodiments, a file defining the data format specification for each of one or more predefined data types may be stored and be chosen and accessed according to a field or a data type of the first data message. The data format of the plurality of data words may include the endianness of the data words, a number of bytes as a length of each data word, and an encoding of the each data word, e.g., identification of each data word as a signed byte, unsigned byte, signed short, unsigned short, signed integer, unsigned integer, signed long, unsigned long, floating point, double precision floating point, Boolean, character, string, or the like. The data format may be specific to a particular computing system implementation, and may specify the quantity, data format definition, and order of the data words in the first data message. In some embodiments, the data format of the data words may be determined according to the source of the first data message, which may be identified through the computer networking protocol by which the first data message is received. In some embodiments, the data format of the data words may be predetermined or known a priori, and no analysis of a data format specification may be performed to determine the data format when the data format is predetermined.

In an operation 440, a plurality of data format definitions of the data format specification that defines a data format of each of the plurality of data words according to a data type of the first data message may be stepped through while stepping through the plurality of data words at intervals according to the data format of each of the plurality of data words. For example, if an initial data format definition specifies that the corresponding initial data word in the first data message is 4 bytes long, the initial data word may be processed according to the initial data format definition and then the next data format definition may be processed in conjunction with the next data word which begins 4 bytes following the beginning of the initial data word in the first data message. In various embodiments, this may be performed by an endian conversion element 280 (shown in FIG. 2).

In an operation 450, a first data word of the plurality of data words in the first data message may be converted from one endian type to a corresponding second data word of another endian type. The conversion of operation 450 may be performed by the endian conversion element 280, for example, while processing the first data word during operation 440. Operation 450 may be performed for each of the data words processed in operation 440 that have a format definition for which endian conversion is appropriate, e.g., a length greater than one byte. For example, the first data word may be input to an endian conversion element, converted from a big-endian data word to a little-endian data word by the endian conversion element, and output from the endian conversion element as the second data word. The conversion of the first data word from one endian type to another endian type may be according to a data type of the first data message and/or a data format of the first data word. The endian conversion of the first data word may be performed by performing a byte swapping of all the bytes in the first data word from a most significant byte position to a least significant byte position. For example, the most significant byte may be swapped with the least significant byte, then the next most significant byte may be swapped with the next least significant byte, etc., until all the bytes of the first data word are swapped to perform the endian conversion of the first data word.

In an operation 460, a second data message having the second data word may be transmitted via a computer networking protocol, e.g., TCP/IP. The second data message may be transmitted by a data transmitter 290 (shown in FIG. 2) over a network/bus 210 within a computer system using the computer networking protocol to an end user of the second data message. The end user may be specified according to the network addressing information for the end user received in operation 410, or according to predetermined end user network addressing information stored in a memory. The computer networking protocol used to transmit the second data message may be the same as the computer networking protocol by which the first data message is received in operation 410. In some embodiments, the computer networking protocol used to transmit the second data message may be different from the computer networking protocol by which the first data message is received in operation 410. The second data message may be transmitted to a different location than that from which the first data message was received. A data type of the second data message may be determined according to the data type of the first data message. A specification of the data type of the second data message and/or a data format of each data word in the second data message may be transmitted in conjunction with the second data message. The specification of the data type of the second data message may be provided as a field within the second data message itself. In some embodiments, the data type of the second data message may be set to be different than the data type of the first data message.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the claims, along with the full range of equivalents to which such claims are entitled.

What is claimed is:

1. A method of converting data from one endian type to another endian type, the method comprising:
receiving a first data message having a plurality of data words via a computer networking protocol;
stepping through a plurality of data format definitions of a data format specification that defines a data format of each of the plurality of data words according to a data type of the first data message while stepping through the plurality of data words at intervals according to the data format of each of the plurality of data words;
converting a first data word of the plurality of data words from one endian type to a corresponding second data word of another endian type by byte swapping bytes of the first data word according to the data format of the first data word; and
transmitting a second data message having the second data word via the computer networking protocol.

2. The method of claim 1, further comprising determining the data type of the first data message by analyzing the first data message.

3. The method of claim 1, wherein the data format definition of the first data word specifies a byte offset of the first data word relative to a start of the first data message.

4. The method of claim 1, further comprising converting a plurality of first data words in the first data message from one endian type to a plurality of corresponding second data words of another endian type according to corresponding data format definitions of the data format specification.

5. The method of claim 1, wherein the data format specification includes a data description file.

6. The method of claim 5, wherein the data description file has a file type selected from the group consisting of a database file type, extensible markup language (XML) file type, or a Java Script Object Notation (JSON) file type.

7. The method of claim 1, wherein the data format specification includes information specifying whether the first data word is big-endian data or little-endian data.

8. The method of claim 1, wherein the data format definition of the first data word specifies a number of bytes in the first data word.

9. The method of claim 1, wherein the data format definition of the first data word includes an encoding selected from the group consisting of signed byte, unsigned byte, signed short, unsigned short, signed integer, unsigned integer, signed long, unsigned long, floating point, double precision floating point, Boolean, character, and string.

10. The method of claim 1, further comprising setting a data type of the second data message according to the data type of the first data message.

11. The method of claim 1, further comprising setting a data type of the second data message that is different from the data type of the first data message.

12. A data structure endian conversion system, comprising:
a data receiver to receive a first data message having a plurality of data words via a computer networking protocol;
an endian conversion element to step through a plurality of data format definitions of a data format specification that defines a data format of each of the plurality of data words according to a data type of the first data message while stepping through the plurality of data words at intervals according to the data format of each of the plurality of data words, and to convert a first data word of the plurality of data words from one endian type to a corresponding second data word of another endian type by byte swapping bytes of the first data word according to the data format of the first data word; and
a data transmitter to transmit a second data message having the second data word via the computer networking protocol.

13. The data structure endian conversion system of claim 12, further comprising a data type determination element that determines the data type of the first data message by analyzing the first data message.

14. The data structure endian conversion system of claim 12, further comprising a data format determination element that determines the data format of each of the plurality of data words according to the data format specification.

15. The data structure endian conversion system of claim 12, wherein the data format specification includes a data description file having a file type selected from the group consisting of a database file type, extensible markup language (XML) file type, or a Java Script Object Notation (JSON) file type.

16. At least one non-transitory machine-readable medium including instructions that, when executed by a machine, cause the machine to perform the following operations:
receiving a first data message having a plurality of data words via a computer networking protocol;
stepping through a plurality of data format definitions of a data format specification that defines a data format of each of the plurality of data words according to a data type of the first data message while stepping through the plurality of data words at intervals according to the data format of each of the plurality of data words;
converting a first data word of the plurality of data words from one endian type to a corresponding second data word of another endian type by byte swapping bytes of the first data word according to the data format of the first data word; and
transmitting a second data message having the second data word via the computer networking protocol.

17. The non-transitory machine-readable medium of claim 16, further including instructions that, when executed by a machine, cause the machine to perform the operation of determining the data type of the first data message by analyzing the first data message.

18. The non-transitory machine-readable medium of claim 16, wherein the data format specification includes a data description file having a file type selected from the group consisting of a database file type, extensible markup language (XML) file type, or a Java Script Object Notation (JSON) file type.

19. The non-transitory machine-readable medium of claim 16, further including instructions that, when executed by a machine, cause the machine to perform the operation of converting a plurality of first data words in the first data message from one endian type to a plurality of corresponding second data words of another endian type according to corresponding data format definitions in the data format specification.

20. The non-transitory machine-readable medium of claim 16, further including instructions that, when executed by a machine, cause the machine to perform the operation of setting a data type of the second data message according to the data type of the first data message.
